(19) United States
(12) Patent Application Publication
(10) Pub. No.: US 2007/0228732 A1
(43) Pub. Date: Oct. 4, 2007

(54) Pipe Joint Having a Defined Sealing Effect

(76) Inventor: Dieter Schwalm, Oerlinghausen (DE)

Correspondence Address: WILLIAM COLLARD;COLLARD & ROE, P.C., 1077 NORTHERN BOULEVARD, ROSLYN, NY, 11576, US

(21) Appl. No.: 11/587,685

(22) PCT Filed: Apr. 20, 2005
(86) PCT No.: PCT/EP05/04191

§ 371 Date: Oct. 26, 2006

(30) Foreign Application Priority Data
Apr. 26, 2004 (DE) 10 2004 020 478.0

(51) Int. Cl. F16L 21/00

(52) U.S. Cl. 285/399

(57) ABSTRACT

The subject matter of this present invention is a pipe joint with a socket (1) and a pipe (2), that is closed by pushing a ring (3) onto the socket (1). The joint further comprises a sealing element (4) that is placed into a chamber (5) of the socket (1). The chamber is executed as a diametral expansion of the socket (1) and is deformed in a defined manner when the ring (3) is pushed on. Due to this the sealing element (4) between the wall of the chamber (5) and the pipe (2) is compressed. Furthermore, when the joint is closed, the socket (1) is compressed with the pipe (2), due to which a mechanically stable joint is produced, that additionally serves as an emergency seal.

This present invention concerns a joining of a pipe with a socket according to the preamble of claim 1. Such a joint is known as the second embodiment of DE 44 12 615 A1.

It is a disadvantage of this prior known joint, that according to its principle the pipe is pushed onto the socket and is rotated radially at the same time. Especially when using metal pipes, the rotation leads to increased assembly forces or may require a heating up of the ends of the pipes prior to assembly. The use of this joint is practically limited to plastic pipes. Furthermore, the sealing element, that is placed into the chamber of the socket, may get twisted when pushing on the pipe in the direction of pushing or even extruded over the outer edge of the chamber in the gap between the pipe and the socket. Both will lead to the damaging of the sealing element.

Therefore it is the object of this present invention to specify a joint, that can be closed by using slight forces and wherein there is no danger that its seal will get damaged during the assembly.

This objective is achieved by a joint according to claim 1.

A basic idea of this present invention is to insert the pipe into the socket without any deformation and to deform both parts only after pushing the ring onto the socket in such a manner, that the required strength and seal of the joint will be produced. The joint will be deformed in two places, namely in the region of the chamber, and preferably at the end. By pushing the ring onto the socket, the chamber undergoes a defined deformation, that compresses the sealing element in such a manner, that it achieves the best possible sealing effect. Excessive stresses, that can damage particularly soft seals, are thus effectively avoided.

The advantageous development of the invention is that the chamber and the sealing element placed into it are so dimensioned, that the sealing element on its own does not abut against the pipe when the pipe is inserted into the socket. The sealing element should be pressed against the pipe only when the ring is pushed on. The decisive advantage of this development is that the sealing element cannot be twisted when the pipe is inserted. By virtue of this action a damaging of the sealing element during assembly is almost out of question.

The socket advantageously has a locating shoulder. The purpose of this is to be grasped by a pliers-like assembly tool, that is used to push the ring onto the socket. Such assembly tools are known per se, they are similar to a pair of pliers, wherein the first cheek grasps the locating shoulder and the other cheek the end of the ring.

The locating shoulder has preferably a bearing surface, on which the ring rests with a third cylindrical section when the joint is closed. By virtue of this the ring obtains a particularly secure seat. Furthermore, the cheek, with which the assembly tool abuts against the assembly shoulder, can simultaneously serve as a stop for the ring to be pushed on.

The diameter of the second cylindrical section is to be so dimensioned, that it constricts the pipe by more than 0.2%. For steel pipes an upsetting of 0.2% means a plastic deformation, by virtue of which the joint will be partly a form-locking one and consequently very stable.

As sealing element a circular sealing ring (O-ring) is particularly suitable. Circular sealing rings are considered standard industrial seals and are available with a variety of diameters and materials.

The chamber has preferably the design of a body of rotation, the axis of its rotation corresponding to the longitudinal axis of the joint and the rotational surface of which is a semi-circle. Such a (circular) chamber is particularly suitable to accommodate a circular sealing ring. Equally, chambers with rectangular cross-section (square chambers) may be provided, into which circular sealing rings or sealing elements of other types can be placed.

This present invention is now explained based on the drawings of an embodiment. For this purpose they show in:

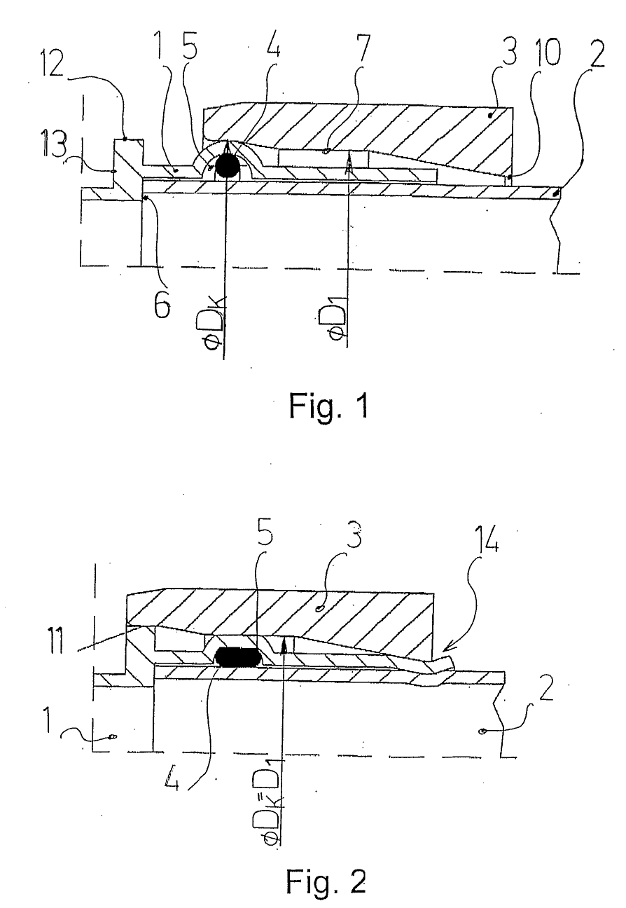

FIG. 1—a joint with a circular chamber, open;

FIG. 2—a joint with a circular chamber, closed;

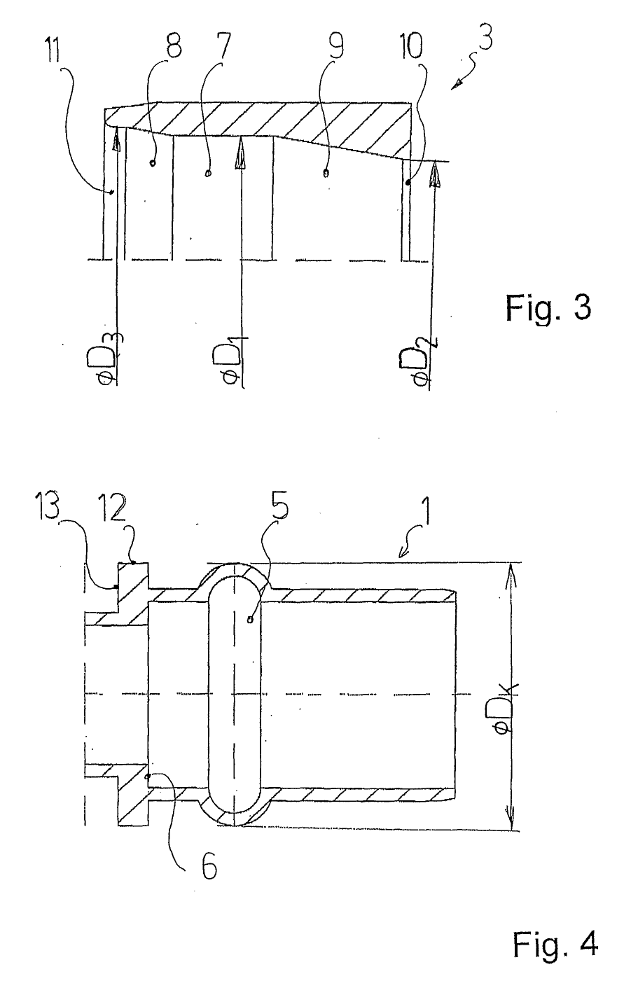

FIG. 3—a ring;

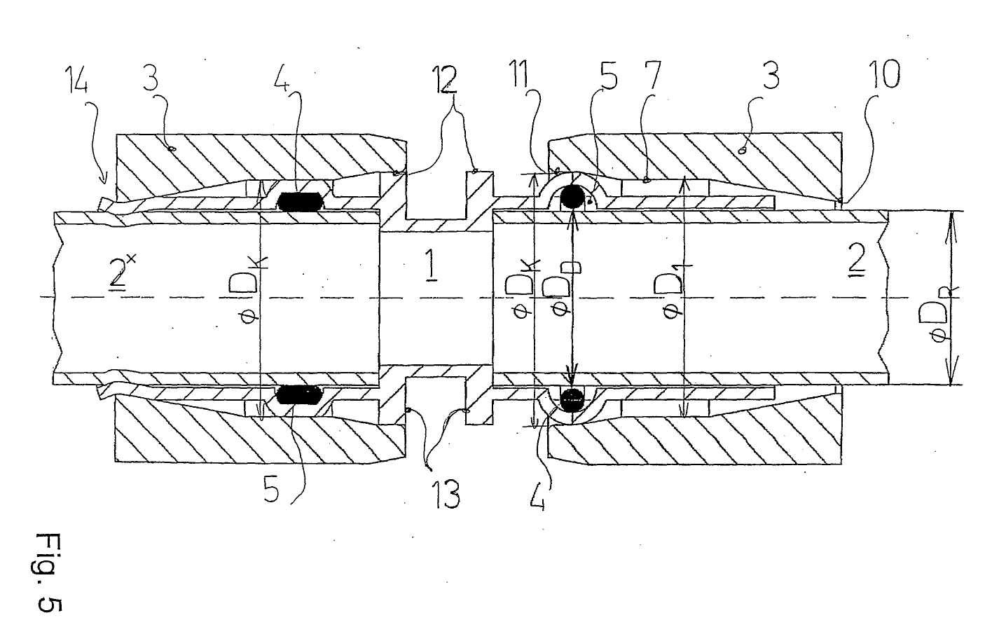

FIG. 4—a socket with a circular chamber;

FIG. 5—a joint for two pipes, with circular chambers, partly open, partly closed,

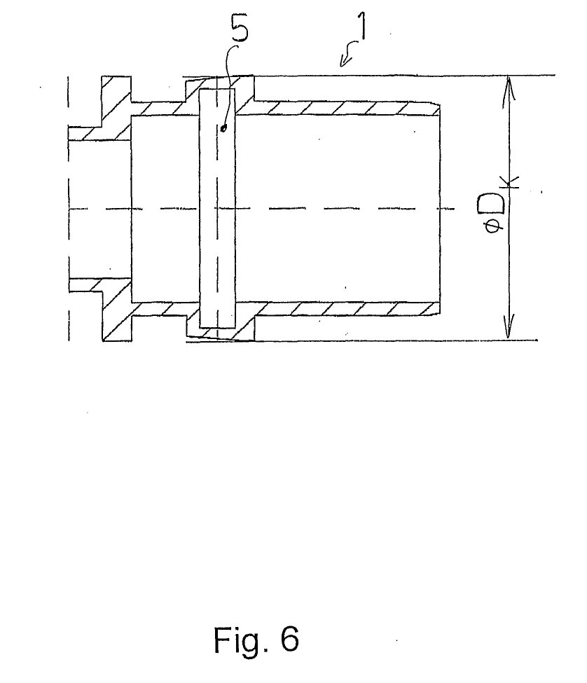

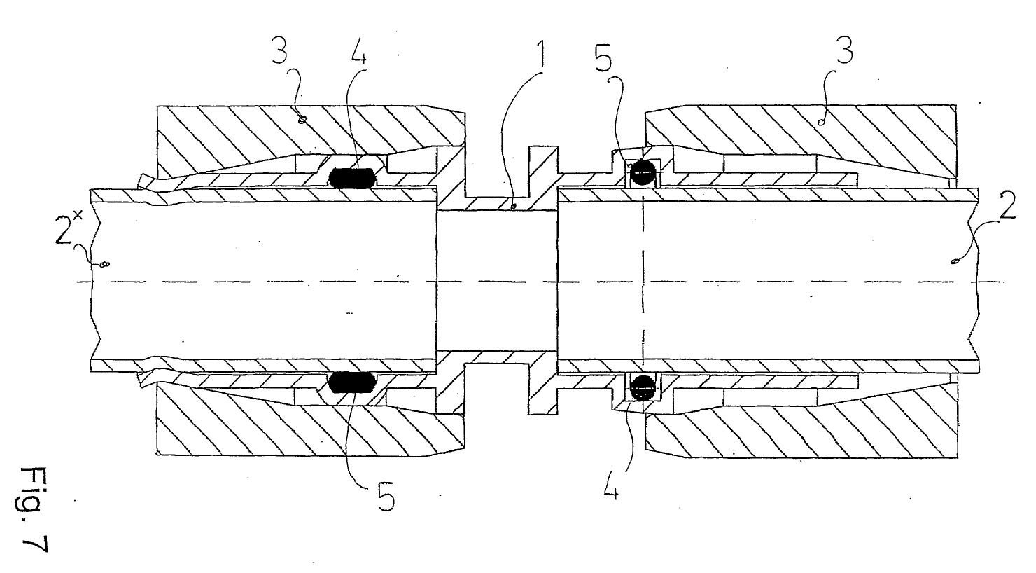

FIG. 6—a socket with a rectangular chamber;

FIG. 7—a joint for two pipes, with rectangular chambers, partly open, partly closed.

In the simplest case a joint according to the invention comprises a sleeve-like socket 1, a pipe 2, a ring 3 and a sealing element 4, that is inserted into a chamber 5 of the socket 1. In the case of the sealing element 4 one deals with a commercially available circular sealing ring made from an elastomer. The other components of the joint are made from metal, but may also be from plastic material. The chamber 5 is executed as a local diametral expansion of the sleeve-like socket 1. The pipe 2 is inserted into the socket 1 without any deformation. The depth of insertion is limited by a shoulder 6. In FIGS. 1-5 the chamber 5 is a circular chamber, i.e. a body of rotation, the rotational surface of which is a semi-circle. The sealing element 4 always abuts against the wall of the chamber 5, it is under light tension even in the case of an open joint, so that not to fall out from the chamber 5. The inside diameter D_{D} of the undeformed sealing element is greater than the outside diameter D_{R} of the pipe. Consequently, when the pipe 2 is introduced into the socket 1, the sealing element 4 does not get into contact with the pipe 2 and therefore does not get twisted or damaged in some other manner.

To close the joint, the pipe 2 is first inserted into the socket 1 and then the ring 3 is pushed onto the socket 1. On its inside the ring 3 has five functional surfaces; cf. FIG. 3. Approximately in the middle of it there is a first cylindrical section 7, that is flanked on both sides by tapered sections 8, 9. The ring 3 converges via the tapered section 9 to a second cylindrical section 10, having a diameter of D₂. The ring 3 expands via the other tapered surface 8 towards its front end and at the front end has a third cylindrical section 11, the diameter of which is designated in the following as D₃. To facilitate the pushing on, the third cylindrical section 11 is rounded towards the outside.

To close the joint, the ring 3 is pushed on to the socket 1, until the third cylindrical section 11 rests on a shoulder surface 12, that is a part of the locating shoulder 13 of the socket 1. The locating shoulder 13 serves as engagement point for the cheek of a pliers-like assembly tool (not illustrated), the second cheek of which grips the end of the ring 3 and pushes it onto the socket 1. During the pushing on of the ring 3 the cheek, engaging the locating shoulder 13, also serves as stop for the ring 3.

When the joint is open, the outside diameter D_{K} of the chamber is approximately the same as the diameter D₃ of the third cylindrical section 11. During pushing on the first tapered section 8 reduces the diameter D_{K} of the chamber 5 down to the diameter D₁ of the first cylindrical section 7. In this process the sealing element 4 is deformed in such a manner, that it will nestle against the wall of the chamber 5 on the one hand and against the wall of the pipe 2 on the other; see FIG. 2. In the deformed state the chamber 5 is almost completely filled by the sealing element 4. By virtue of this the socket 1 and the pipe 2 are sealed from one another.

Simultaneously with the ring 3 being pushed on, an end section 14 of the sleeve-like socket 1 is pressed at a point against the wall of the pipe 2, situated below it. This takes place over the second tapered section 9. The diameter D₂ of the second cylindrical section 10 determines the radial constriction of the pipe. When steel pipes are used, this should be more than 0.2%, so that a plastic deformation will take place. In this case a form-lock is produced, that is capable to accept axial forces between the socket 1 and the pipe 2. Consequently, the sealing element 4 is relieved. Moreover, the compressed position at the end section 14 of the socket 1 serves as an emergency seal, should the sealing element 4 fail.

FIG. 5 shows an application example to join two pipes 2, 2*. The sockets 1 are symmetrical in this case. On the left hand side of the drawing the joint is closed, on the right hand side it is open.

FIGS. 6 and 7 show a design variation of the joint, wherein the chamber 5 has a rectangular cross-section. A circular sealing ring or another sealing element 4 can be placed in the rectangular (square) chamber 5.

1-8. (canceled)

9. A joint of a pipe (2) with a socket (1), wherein the socket (1) has a chamber (5), into which a sealing element (4) is placed, that in the case of a closed joint nestles against the wall of the chamber (5) on the one hand and against the pipe (2) on the other, while the joint comprises a ring (3) that for the purpose of closing the joint can be pushed onto the socket (1) and on its inside has two cylindrical sections (7, 10), while the diameter (D₁) of the first cylindrical section (7) is greater than the diameter (D₂) of the second cylindrical section (10), and wherein the first cylindrical section (7) and the second cylindrical section (10) are connected with one another by way of a conical section (9), wherein the pipe (2) can be pushed into the socket (1) and the chamber (5) is executed as an expansion of the diameter of the socket (1), the outside diameter (D_{K}) of which exceeds the diameter (D₁) of the first cylindrical section (7) in the case of an open joint and is reduced to this diameter (D₁) when the joint is closed, and whereby the socket (1) has a locating shoulder (13), the purpose of which is to be grasped by a cheek of a pliers-like assembly tool, by means of which the ring (3) can be pushed onto the socket (1), wherein the second cylindrical section (10) radially constricts the pipe (2) in the case of a closed joint and in this manner compresses pipe (2) and socket (1) together, wherein when the ring (3) is pushed on over the conical section (9), an end-side section (14) of the socket (1) is pressed against the wall of the pipe (2) that lies underneath, and that the locating shoulder (13) has a bearing surface (12) on which the ring (2) rests with a third cylindrical section (11) when the joint is closed.

10. A joint according to claim 9, wherein when the pipe is inserted into the socket (1) and the ring (3) is not pushed onto the socket (1), the sealing element (4) does not abut against the pipe (2).

11. A joint according to claim 9, wherein the diameter (D₂) of the second cylindrical section (10) is to be so dimensioned, that in the case of a closed joint it constricts the pipe (2) by more than 0.2%.

12. A joint according to claim 9, wherein the sealing element (4) is a circular sealing ring.

13. A joint according to claim 9, wherein the chamber (5) has the design of a body of rotation, the axis of its rotation corresponds to the longitudinal axis of the joint and the rotational surface of which is a semi-circle.

14. A joint according to claim 9, wherein the chamber (5) has the design of a body of rotation, the axis of its rotation corresponds to the longitudinal axis of the joint and the rotational surface of which is a rectangle.
